(19) United States
(12) Patent Application Publication
(10) Pub. No.: US 2012/0177980 A1
(43) Pub. Date: Jul. 12, 2012

(54) LITHIUM SECONDARY BATTERY

(76) Inventors: Norio IWAYASU, Hitachinaka (JP); Jinbao Zhao, Xiamen (CN); Hidetoshi Honbou, Hitachinaka (JP); Yuki Okuda, Hitachi (JP)

(21) Appl. No.: 13/217,516

(22) Filed: Aug. 25, 2011

(30) Foreign Application Priority Data
Jan. 7, 2011 (JP) 2011-001571

(51) Int. Cl. H01M 10/056; C08F 120/28; H01M 2/02; C08F 120/06

(52) U.S. Cl. 429/163; 521/38; 429/324; 429/341; 429/340

(57) ABSTRACT

The gas generation and the decrease in battery capacity during high temperature storage of a lithium secondary battery are suppressed. The electrolyte contains a polymerizable compound or a polymer, the polymerizable compound contains a compound having an aromatic functional group and a polymerizable functional group and a compound having a complex-forming functional group forming a complex with a metal ion and a polymerizable functional group, and the polymer has the complex-forming functional group, the aromatic functional group and a residue of the polymerizable functional group.

### BACKGROUND OF THE INVENTION

1. Field of the Invention

The present invention relates to a lithium secondary battery.

2. Background Art

A lithium secondary battery has a high energy density and is widely used for a notebook computer, a cell phone and the like by taking advantage of the characteristics of the battery. In recent years, an electric vehicle has attracted increasing attention from the viewpoint of preventing global warming caused by an increase in carbon dioxide and a lithium secondary battery has been studied to be applied as the power source of electric vehicles.

A lithium secondary battery, which has these excellent characteristics, has problems. One of the problems is the improvement in safety. Above all, the important problem is the improvement in safety of a battery during high temperature storage.

If a lithium secondary battery is stored at a high temperature, an electrolytic solution is decomposed in the inside of the battery to generate a gas. If a gas is generated, a battery can is swollen, thereby decreasing the safety of the battery. Since this problem becomes prominent in case of a square battery, countermeasures are required. In addition, a decrease in battery capacity also causes a problem.

For the above reasons, an attempt to suppress the gas generation has been studied by adding an additive into the electrolytic solution.

JP Patent Publication (Kokai) No. 2003-331920A discloses a nonaqueous electrolyte containing a fluorine-containing sulfonate compound for the purpose of suppressing the gas generation.

JP Patent Publication (Kokai) No. 2004-327445A discloses an electrolyte for a lithium battery containing a sulfonate electrolyte additive for the purpose of improving the safety and electrochemical characteristics of a battery.

JP Patent Publication (Kokai) No. 2008-41635A discloses a nonaqueous electrolyte composition containing a phosphate ester and a compound having a sulfone structure for the purpose of preventing the swelling deformation of a battery outer package during high temperature storage.

Since the sulfonate compound described in JP Patent Publication (Kokai) No. 2003-331920A and JP Patent Publication (Kokai) No. 2004-327445A reacts on the negative electrode, it has room for improvement in reducing the battery performance.

The phosphate ester described in JP Patent Publication (Kokai) No. 2008-41635A also has room for improvement in that, as with JP Patent Publication (Kokai) No. 2003-331920A, it reacts on the negative electrode.

An object of the present invention is to suppress the gas generation and the decrease in battery capacity during high temperature storage of the lithium secondary battery.

### SUMMARY OF THE INVENTION

The lithium secondary battery of the present invention contains a positive electrode, a negative electrode and an electrolyte and is characterized in that the electrolyte contains a polymerizable compound or a polymer, the polymerizable compound contains a compound having an aromatic functional group and a polymerizable functional group and a compound having a complex-forming functional group forming a complex with a metal ion and a polymerizable functional group, and the polymer has the complex-forming functional group, the aromatic functional group and a residue of the polymerizable functional group.

According to the present invention, the gas generation and the decrease in battery capacity during high temperature storage can be suppressed without decreasing the battery performance.

### BRIEF DESCRIPTION OF THE DRAWINGS

FIG. 1 is a partial cross-sectional view showing a lithium secondary battery (cylindrical lithium-ion battery) of Examples.

FIG. 2 is a cross-sectional view showing a lithium secondary battery (laminate-type lithium-ion battery) of Examples.

FIG. 3 is a perspective view showing a lithium secondary battery (square-type lithium-ion battery) of Examples.

FIG. 4 is an A-A cross-sectional view of FIG. 3.

### DETAILED DESCRIPTION OF THE PREFERRED EMBODIMENTS

As a result of earnest studies, the present inventor found an inhibitor capable of suppressing the gas generation and the decrease in battery capacity during high temperature storage without decreasing the battery performance.

Hereinafter, there will be described a lithium secondary battery related to an embodiment of the present invention as well as a polymer used therefore, an electrolytic solution for a lithium secondary battery and a positive electrode protective agent for a lithium secondary battery.

The lithium secondary battery contains a positive electrode, a negative electrode and an electrolyte and is characterized in that the electrolyte contains a polymerizable compound or a polymer, the polymerizable compound contains a compound having an aromatic functional group and a polymerizable functional group and a compound having a complex-forming functional group forming a complex with a metal ion and a polymerizable functional group, and the polymer has the complex-forming functional group, the aromatic functional group and a residue of the polymerizable functional group.

In the lithium secondary battery, the polymerizable compound further contains a compound having a highly polar functional group having a functional group with highly polarity and a polymerizable functional group and the polymer further has a highly polar functional group.

In the lithium secondary battery, the aromatic functional group has a complex-forming functional group.

In the lithium secondary battery, the polymerizable compound or the polymer has a hydrocarbon group or an oxyalkylene group having 1 to 20 carbon atoms between the aromatic functional group and the polymerizable functional group.

In the lithium secondary battery, the complex-forming functional group is represented by —OR, —SR, —COOR or —SO₃R, wherein R is H, an alkali metal, an alkaline earth metal or an alkyl group.

In the lithium secondary battery, the electrolyte contains a polymerizable compound represented by the following chemical formula (1) or (2).

Z¹—X-A. Chemical Formula (1)

Z¹-A Chemical Formula (2)

wherein, Z¹ is a polymerizable functional group, X is a hydrocarbon group or an oxyalkylene group having 1 to 20 carbon atoms, A is an aromatic functional group and at least a portion of the aromatic functional group may be substituted with —OR, —SR, —COOR or —SO₃R, wherein R is H, an alkali metal, an alkaline earth metal or an alkyl group.

In the lithium secondary battery, the electrolyte contains a polymer obtained by polymerizing the polymerizable compound.

In the lithium secondary battery, the electrolyte contains a polymer represented by the following chemical formula (3) or (4).

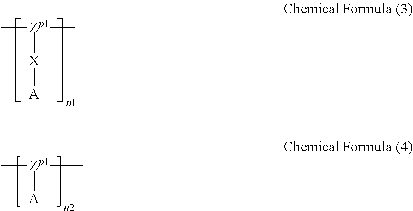

wherein, Z^{p1} is a residue of the polymerizable functional group, X is a hydrocarbon group or an oxyalkylene group having 1 to 20 carbon atoms, A is an aromatic functional group and at least a portion of the aromatic functional group may be substituted with —OR, —SR, —COOR or —SO₃R, wherein R is H, an alkali metal, an alkaline earth metal or an alkyl group; and further, n1 and n2 are each an integer of 1 or more.

In the lithium secondary battery, the electrolyte contains polymerizable compounds represented by the following chemical formulas (5) and (6).

Z²—Y Chemical Formula (5)

Z³—W Chemical Formula (6)

wherein, Z² is a polymerizable functional group, Y is a complex-forming functional group forming a complex with a metal ion, Z³ is a polymerizable functional group, and W is a highly polar functional group having a functional group with high polarity.

In the lithium secondary battery, the electrolyte contains a polymer obtained by copolymerizing a polymerizable compound represented by the above chemical formula (1) or (2) with polymerizable compounds represented by the above chemical formulas (5) and (6).

In the lithium secondary battery, the electrolyte contains a polymer represented by the chemical formula (7) or (8).

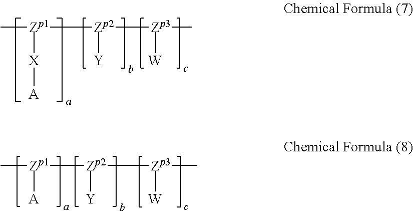

wherein, Z^{p1}, Z^{p2} and Z^{p3} are each a residue of the polymerizable functional group, a, b and c are expressed in mole %, X is a hydrocarbon group or an oxyalkylene group having 1 to 20 carbon atoms, A is an aromatic functional group, and at least a portion of the aromatic functional group may be substituted with —OR, —SR, —COOR or —SO₃R, wherein R is H, an alkali metal, an alkaline earth metal or an alkyl group; and further, Y is a complex-forming functional group forming a complex with a metal ion, and W is a highly polar functional group having a functional group with high polarity.

In the lithium secondary battery, the electrolyte contains a polymer represented by the following chemical formula (9).

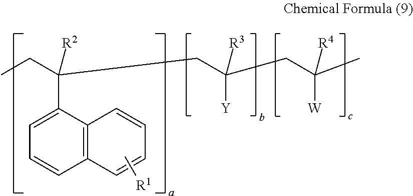

wherein, R¹ is H, a chain hydrocarbon group, a cyclic hydrocarbon group, an aromatic group, OR, SR, COOR or SO₃R, wherein R is H, an alkali metal, an alkaline earth metal or an alkyl group; and further, a, b and c are expressed in mole %, Y is a complex-forming functional group forming a complex with a metal ion, W is a highly polar functional group having a functional group with high polarity, and R², R³ and R⁴ are each H or a hydrocarbon group.

In the lithium secondary battery, the electrolyte contains a polymer represented by the following chemical formula (10).

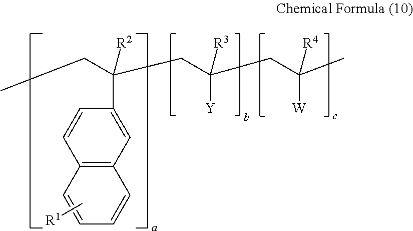

wherein, R¹ is H, a chain hydrocarbon group, a cyclic hydrocarbon group, an aromatic group, OR, SR, COOR or SO₃R, wherein R is H, an alkali metal, an alkaline earth metal or an alkyl group; and further, a, b and c are expressed in mole %, Y is a complex-forming functional group forming a complex with a metal ion, W is a highly polar functional group having a functional group with high polarity, and R², R³ and R⁴ are each H or a hydrocarbon group.

The polymer is represented by the above chemical formula (9).

The polymer is represented by the above chemical formula (10).

The electrolytic solution for a lithium secondary battery contains a polymerizable compound or a polymer contained in the lithium secondary battery.

In the positive electrode protective agent for a lithium secondary battery, a polymerizable compound or a polymer contained in the lithium secondary battery is used as an active component.

A method for manufacturing the polymer comprises preparing a mixture containing a polymerizable compound having an aromatic functional group and a polymerizable functional group, and a polymerizable compound having a complex-forming functional group forming a complex with a metal ion and a polymerizable functional group and polymerizing the polymerizable compound.

In the method for manufacturing the polymer, the above-mentioned mixture further contains a polymerizable compound having a highly polar functional group having a functional group with high polarity and a polymerizable functional group.

In the method for manufacturing the polymer, the polymerizable compound has a hydrocarbon group or an oxyalkylene group having 1 to 20 carbon atoms between the aromatic functional group and the polymerizable functional group.

In the method for manufacturing the polymer, the above-mentioned mixture contains a polymerizable compound represented by the above chemical formula (1) or (2) and polymerizable compounds represented by the above chemical formulas (5) and (6).

In the method for manufacturing the polymer, the reaction is carried out by mixing a polymerization initiator with the above-mentioned mixture.

The lithium secondary battery may be square in shape.

The polymerizable functional group is not particularly limited as long as it causes a polymerization reaction, and an organic group having an unsaturated double bound such as a vinyl group, an acryloyl group or a methacryloyl group is preferably used.

Examples of the hydrocarbon group having 1 to 20 carbon atoms include an aliphatic hydrocarbon group such as a methylene group, an ethylene group, a propylene group, an isopropylene group, a butylene group, an isobutylene group, a dimethylethylene group, a pentylene group, a hexylene group, a heptylene group, an octylene group, an isooctylene group, a decylene group, an undecylene group and a dodecylene group; and an alicyclic hydrocarbon group such as a cyclohexylene group, and a dimethylcyclohexylene group.

Examples of the oxyalkylene group include an oxymethylene group, an oxyethylene group, an oxypropylene group, an oxybutylene group and an oxytetramethylene group.

The aromatic functional group is a functional group having 20 or less carbon atoms, which satisfies Huckel's rule. Specifically, examples of the aromatic functional group include a cyclohexyl benzyl group, a biphenyl group and a phenyl group as well as a condensate thereof such as a naphthyl group, an anthryl group, a phenanthryl group, a triphenylene group, a pyrene group, a chrysene group, a naphthacene group, a picene group, a perylene group, a pentaphene group, penthacene group and an acenaphthylene group. A portion of these aromatic functional groups may be substituted. Further, the aromatic functional group may contain elements other than carbon in the aromatic ring. Specifically, they are elements such as S, N, Si and O.

The effect of the present invention is obtained by the reaction of the aromatic compound introduced into the polymer on the positive electrode. For this reason, the selection of the aromatic compound becomes very important. From the above viewpoint, preferred are a phenyl group, a cyclohexylbenzyl group, a biphenyl group, a naphthyl group, an anthracene group and a tetracene group, and a naphthyl group, an anthracene group and a tetracene group are particularly preferred.

In the present invention, the polymer refers to a compound obtained by polymerizing the polymerizable compound. Although both the polymerizable compound and the polymer can be used in the present invention, from the viewpoint of the electrochemical stability, it is preferred that a polymer is prepared by preliminarily polymerizing the polymerizable compound and then the polymer after purification is used. Polymerization may be carried out by any of bulk polymerization, solution polymerization and emulsion polymerization, which are conventionally known. In addition, the polymerizing method is not particularly limited, but radical polymerization is preferably used. In the case of polymerization, a polymerization initiator may or may not be used, and a radical polymerization initiator is preferably used from the viewpoint of easy handling. The polymerization method using the radial polymerization initiator can be carried out in the temperature range and polymerization time usually employed.

The blending amount of the polymerization initiator is 0.1 to 20% by weight and preferably 0.3 to 5% by weight, based on the polymerizable compound.

Examples of the radical polymerization initiator include an organic peroxide such as t-butylperoxy pivalate, t-hexylperoxy pivalate, methyl ethyl ketone peroxide, cyclohexanone peroxide, 1,1-bis(t-butylperoxy)-3,3,5-trimethyl cyclohexane, 2,2-bis(t-buthylperoxy)octane, n-butyl-4,4-bis(t-butylperoxy)valerate, t-butyl hydroperoxide, cumene hydroperoxide, 2,5-dimethylhexane-2,5-dihydroperoxide, di-t-butyl peroxide, t-butylcumyl peroxide, dicumyl peroxide, α,α-bis(t-butylperoxy-m-isopropyl)benzene, 2,5-dimethyl-2,5-di(t-butylperoxy)hexane, benzoylperoxide and t-butylperoxypropyl carbonate; and an azo compound such as 2,2′-azobisisobutyronitrile, 2,2′-azobis(2-methylbutyronitrile), 2,2′-azobis(4-methoxy-2,4-dimethylvaleronitrile), 2,2′-azobis(2,4-dimethylvaleronitrile), 1,1′-azobis(cyclohexane-1-carbonitrile), 2-(carbamoylazo)isobutyronitrile, 2-phenylazo-4-methoxy-2,4-dimethyl-valeronitrile, 2,2-azobis(2-methyl-N-phenylpropionamidine)dihydrochloride, 2,2′-azobis[N-(4-chlorophenyl)-2-methylpropionamidine]dihydrochloride, 2,2′-azobis[N-hydroxyphenyl]-2-methylpropionamidine]dihydrochloride, 2,2′-azobis[2-methyl-N-(phenylmethyl)propionamidine]dihydrochloride, 2,2′-azobis[2-methyl-N-(2-propenyl)propionamidine]dihydrochloride, 2,2′-azobis(2-methylpropionamidine)dihydrochloride, 2,2′-azobis[N-(2-hydroxyethyl)-2-methylpropionamidine]dihydrochloride, 2,2′-azobis[2-(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis{2-[1-(2-hydroxyethyl)-2-imidazolin-2-yl]propane} dihydrochloride, 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis{2-methyl-N-[1,1-bis(hydroxymethyl)ethyl]propionamide}, 2,2′-azobis[2-methyl-N-(2-hydroxyethyl)propionamide], 2,1′-azobis(2-methylpropionamide)dihydrate, 2,2′-azobis(2,4,4-trimethylpentane), 2,2′-azobis(2-methylpropane), dimethyl 2,2′-azobisisobutyrate, 4,4′-azobis(4-cyanovalerate) and 2,2′-azobis[2-(hydroxymethyl)propionitrile].

In the above chemical formula (3), Z^{p1} is a residue of the polymerizable functional group. X and A are the same as those in the above chemical formula (1).

In the above chemical formula (5), Z² is a polymerizable functional group. The polymerizable functional group is not particularly limited as long as it causes a polymerization reaction, and an organic group having an unsaturated double bound such as a vinyl group, an acryloyl group or a methacryloyl group is preferably used.

Y in the above chemical formula (5) is a functional group (functional group forming a complex with a metal ion) containing donor atoms forming a complex with a metal ion, which is a functional group containing O, N, S, P, As or Se. Specifically, preferably used are alcohol (—OR), carboxylic acid (—COOH), ketone (>C═O), ether (—O—), ester (—COOR), amide (—CONH₂), nitroso (—NO), nitro (—NO₂), sulfonic acid (—SO₃R), hypophosphorous acid (—PRO(OR)), phosphorous acid (—PO(OR)₂), arsonic acid (—AsO(OH)₂), primary amine (—NH₂), secondary amine (>NH), tertiary amine (EN), azo (≡N═N—), >C≡N—, amide (═CONH₂), oxime (>C═N—OH), imine (>C═NH), thioalcohol (—SR), thioether (—S—), thioketone (>C═S), thiocarboxylic acid (—COSR), dithiocarboxylic acid (—CSSR), thioamide (—CSNH₂), thiocyanate (—SCN), >P— (primary, secondary or tertiary alkyl- and arylphosphine), >As— (primary, secondary or tertiary alkyl- and arylalcene), selenol (—SeR), selenocarbonyl (>C═Se) and diselenocarboxylic acid (—CSeSeR). Among these, particularly preferred are alcohol (—OR), carboxylic acid (—COOH), sulfonic acid (—SO₃R) and phosphorous acid (—PO(OR)₂). Further, R is H, an alkali metal, alkaline earth metal or an alkyl group.

In the above chemical formula (6), Z³ is a polymerizable functional group. The polymerizable functional group is not particularly limited as long as it causes a polymerization reaction, and an organic group having an unsaturated double bound such as a vinyl group, an acryloyl group or a methacryloyl group is preferably used.

W in the above chemical formula (6) is a highly polar functional group (highly polar functional group). The affinity for the electrolytic solution is increased by selecting a suitable highly polar functional group. Among the highly polar functional groups, an oxyalkylene group [(AO)ₘR], a cyano group, a hydroxyl group and a carboxyl group are preferred, and an oxyalkylene group [(AO)ₘR] and a cyano group are further preferred. By selecting these groups, the electrochemical stability is improved and the battery performance is not deteriorated. The oxyalkylene group in which AO is an ethylene oxide group and R is methyl is preferred, wherein m is 1 to 20, preferably 1 to 10 and particularly preferably 1 to 5.

In the above chemical formula (7), Z^{p1}, Z^{p2} and Z^{p3} are each a residue of the polymerizable functional group. X, A, Y and W are the same as those in the above chemical formulas (1), (5) and (6). a, b and c are expressed in mole %, and 0<a≦100, 0≦b≦100 and 0≦c<100.

In the above chemical formulas (9) and (10), R¹ is H, a chain hydrocarbon group, a cyclic hydrocarbon group, an aromatic group, OR, SR, COOR or SO₃R, wherein R is H, an alkali metal, an alkaline earth metal or an alkyl group; R², R³ and R⁴ are each H or a hydrocarbon group, Y and W are the same as those in the above chemical formula (7); a, b and c are expressed in mole %; and 0<a≦100, 0≦b<100 and 0≦c<100.

The polymer has a number average molecular weight (Mn) of 5×10⁷ or less, preferably 1×10⁶ or less and more preferably 1×10⁵ or less. The deterioration of the battery performance can be suppressed by using a polymer having a low number average molecular weight.

The existence form of the polymerizable compound and the polymer in a lithium secondary battery is not particularly limited, but the polymerizable compound and the polymer are preferably used by allowing to coexist in the electrolytic solution.

The mixture state of the electrolytic solution, the polymerizable compound and the polymer may be a solution in which the electrolytic solution is used as a solvent, or may be a state in which the polymerizable compound and the polymer are suspended in the electrolytic solution.

The concentration (unit: % by weight (wt %)) of the polymerizable compound and the polymer is represented by the following calculation expression (1).

The concentration=(the weight of the polymerizable compound and the polymer)/[(the weight of the electrolytic solution)+(the weight of the polymerizable compound and the polymer)]×100 Calculation Expression (1)

The concentration is 0 to 100%, preferably 0.01 to 5% and particularly preferably 0.05 to 1%. As the value is larger, the ionic conductivity of the electrolytic solution is reduced to deteriorate the battery performance. In addition, as the value is smaller, the effect of the invention is reduced.

The electrolytic solution is prepared by dissolving a supporting electrolyte in a nonaqueous solvent. The nonaqueous solvent is not particularly limited so long as it can dissolve the supporting electrolyte, and examples of the nonaqueous solvent preferably include an organic solvent such as diethyl carbonate, dimethyl carbonate, ethylene carbonate, ethyl methyl carbonate, propylene carbonate, y-butyrolactone, tetrahydrofuran, and dimethoxy ethane. These may be used alone or by mixing two or more kinds thereof.

The supporting electrolyte is not particularly limited so long as it is soluble in a nonaqueous solvent, and examples of the supporting electrolyte preferably include an electrolyte salt such as LiPF₆, LiN(CF₃SO₂)₂, LiN(C₂F₆SO₂)₂, LiClO₄, LiBF₄, LiAsF₆, LiI, LiBr, LiSCN, Li₂B₁₀Cl₁₀ and LiCF₃CO₂. These may be used alone or by mixing two or more kinds thereof. In addition, vinylene carbonate and the like may be added in the electrolytic solution.

The positive electrode is capable of occluding and releasing lithium ions and is an oxide having a layered structure such as LiCoO₂, LiNiO₂, LiMn_{1/3}Ni_{1/3}Co_{1/3}O₂ and LiMn_{0.4}Ni_{0.4}CO_{0.2}O₂, which are represented by the general formula of LiMO₂ (M is a transition metal). An example of the oxide includes an oxide obtained by substituting a portion of M with at least one or more metal elements selected from the group consisting of Al, Mg, Mn, Fe, Co, Cu, Zn, Al, Ti, Ge, W and Zr. In addition, an example of the oxide includes an Mn oxide having a spinel type crystal structure such as LiMn₂O₄ or Li₁₊ₓMn₂₋ₓO₄. Further, LiFePO₄ or LiMnPO₄ having an olivine structure can be used.

In addition, as the negative electrode material, there is used a material prepared by heat treating an easily graphitizable material obtained from natural graphite, petroleum coke, coal pitch coke and the like at a high temperature of 2500° C. or higher, meso-phase carbon, amorphous carbon, a carbon fiber, a metal capable of alloying with lithium or a material prepared by supporting a metal on the surface of carbon particles. For example, there may be used a metal selected from the group consisting of lithium, silver, aluminum, tin, silicon, indium, gallium and magnesium or an alloy thereof. Further, the metal or the oxide of the metal can be utilized as the negative electrode. In addition, lithium titanate can also be used.

As the separator material, there may be used a material composed of a polymer such as polyolefin, polyamide and polyester or a glass cloth using fibrous glass fibers, and the material is not particularly limited as long as it is a reinforcing material which does not adversely affect the lithium secondary battery. Polyolefin is preferably used.

Examples of the polyolefin include polyethylene, polypropylene and the like, the films of which can be laminated for use.

In addition, the air permeability (sec/100 mL) of the separator is 10 to 1000, preferably 50 to 800 and particularly preferably 90 to 700.

Hereinafter, the present invention will be described more specifically using Examples, but the present invention is not limited to these Examples.

<Preparation Method of Positive Electrode>

A positive electrode active material, a conductive agent (SP270: graphite manufactured by Japan Graphite Co., Ltd.) and a binder (KF1120: polyvinylidene fluoride manufactured by KUREHA CORPORATION) were mixed at a ratio of 85:10:10 on the weight basis, followed by adding and mixing in N-methyl-2-pyrrolidone to prepare a slurry solution. The slurry was applied to an aluminum foil with a thickness of 20 μm using a doctor blade method, followed by drying. Thereafter, after pressing, the electrode is cut into a size of 10 cm² to prepare a positive electrode.

<Preparation Method of Negative Electrode>

Graphite was mixed at a ratio of 90:10 on the weight basis, followed by adding and mixing in N-methyl-2-pyrrolidone to prepare a slurry solution. The slurry was applied to an aluminum foil with a thickness of 20 μm using a doctor blade method, followed by drying. The electrode is cut into a size of 10 cm² to prepare a negative electrode.

<Electrolytic Solution>

An electrolytic solution manufactured by Toyama Pure Chemical Industries, Ltd., in which the electrolyte salt is LiPF₆, the solvent is EC/DMC/EMC=1:1:1 (by volume ratio) and the electrolyte salt concentration is 1 mol/L, was used.

<Preparation Method of Laminate Battery>

An electrode group was formed by inserting a separator made of polyolefin between the positive electrode and the negative electrode. The electrolytic solution was poured into the electrode group. Thereafter, the battery was sealed with a laminate made of aluminum to prepare a battery. Subsequently, the battery was initialized by repeating charge and discharge cycle three times.

<Evaluation Method of Battery>

1. Initial Capacity of Laminate Battery

The battery was charged at a current density of 0.1 mA/cm² to the preset upper-limit voltage. The battery was discharged at a current density of 0.1 mA/cm² to the preset lower-limit voltage. The upper-limit voltage was 4.2 V and the lower-limit voltage was 2.5 V. The discharged capacity obtained at the first cycle was used as the initial capacity of the battery.

2. High Temperature Storage Test

The laminate battery prepared was charged at 4.2 V, followed by placing into a constant-temperature bath at 85° C. to store for 24 hours. After storing for 24 hours, the battery was taken out and cooled to room temperature, followed by collecting the generated gas by a syringe.

3. Square Battery Evaluation

A square battery was prepared by using the same material as that of the laminate battery. The size of the square battery was 43 mm in length, 34 mm in width and 4.6 mm in thickness. And, the battery prepared was charged at 4.2 V, followed by placing into a constant-temperature bath at 85° C. to store for 24 hours. After cooling to room temperature, the thickness of the battery was measured. The swelling of the battery was specified by measuring the thickness of the battery at the center point of the battery to determine the thickness of the battery before and after heating.

<Synthesis Method of Polymer>

A monomer was placed into a reaction vessel and a polymerization initiator was added. As the polymerization initiator, AIBN was used. The polymerization initiator was added so that the concentration of the polymerization initiator is 1% by weight based on the total amount of the monomer. Subsequently, the reaction vessel was placed into an oil bath heated at 60° C., followed by heating for 3 hours to synthesize a polymer. After heating, the reaction solvent was removed and the polymer was washed, followed by drying.

### EXAMPLE 1

A polymer A (the above chemical formula (9): R¹ is H, Y is COOH, R² is H, R³ is H, a is 50 mole %, b is 50 mole % and c is 0 mole %) was synthesized by using 1-vinylnaphthalene (1 mol, 154 g) and acrylic acid (1 mol, 72 g). And, the polymer A was dissolved in the electrolytic solution at a concentration of 0.1% by weight to prepare a laminate battery.

In addition, as the positive electrode active material used for the battery evaluation, LiCoO₂ was used. The initial capacity of the laminate battery was 30 mAh. Subsequently, when the high temperature test was carried out, the amount of gas generated was 0.060 mL. Then, a square battery was prepared and the battery capacity was measured. The capacity was 800 mAh. Thereafter, the heating test was carried out in the same manner as the laminate battery, and after cooling, the battery capacity and the swelling of the battery were measured. As a result, the battery capacity was 720 mAh and the swelling of the battery was 1.10 mm.

### EXAMPLE 2

A polymer B (the above chemical formula (10): R¹ is H, Y is COOH, R² is H, R³ is H, a is 50 mole %, b is 50 mole % and c is 0 mole %) was synthesized by using 2-vinylnaphthalene (1 mol, 154 g) and acrylic acid (1 mol, 72 g). And, the polymer B was dissolved in the electrolytic solution at a concentration of 0.1% by weight to prepare a laminate battery. In addition, as the positive electrode active material used for the battery evaluation, LiCoO₂ was used.

The initial capacity of the laminate battery was 30 mAh. Subsequently, when the high temperature test was carried out, the amount of gas generated was 0.065 mL. Then, a square battery was prepared and the battery capacity was measured. The capacity was 800 mAh. Thereafter, the heating test was carried out in the same manner as the laminate battery, and after cooling, the battery capacity and the swelling of the battery were measured. As a result, the battery capacity was 728 mAh and the swelling of the battery was 1.11 mm.

### EXAMPLE 3

A polymer C (the above chemical formula (9): R¹ is H, Y is COOH, W is (CH₂CH₂O)₂CH₃, R² is H, R³ is H, R⁴ is CH₃, a is 30 mole %, b is 35 mole % and c is 35 mole %) was synthesized by using 1-vinylnaphthalene (0.30 mol, 462 g), acrylic acid (0.35 mol, 25.2 g) and diethyleneglycol monomethylether methacrylate (0.35 mol, 65.8 g). The polymer C was dissolved in the electrolytic solution at a concentration of 0.1% by weight to prepare a laminate battery. In addition, as the positive electrode active material used for the battery evaluation, LiCoO₂ was used.

The initial capacity of the laminate battery was 30 mAh. Subsequently, when the high temperature test was carried out, the amount of gas generated was 0.055 mL. Then, a square battery was prepared and the battery capacity was measured. The capacity was 800 mAh. Thereafter, the heating test was carried out in the same manner as the laminate battery, and after cooling, the battery capacity and the swelling of the battery were measured. As a result, the battery capacity was 735 mAh and the swelling of the battery was 1.08 mm.

### EXAMPLE 4

A polymer D (the above chemical formula (9): R¹ is H, Y is COOH, W is (CH₂CH₂O)₂CH₃, R² is H, R³ is H, R⁴ is CH₃, a is 35 mole %, b is 5 mole % and c is 65 mole %) was synthesized by using 1-vinylnaphthalene (0.30 mol, 46.2 g), acrylic acid (0.05 mol, 3.6 g) and diethyleneglycol monomethylether methacrylate (0.65 mol, 122.2 g). The polymer D was dissolved in the electrolytic solution at a concentration of 0.1% by weight to prepare a laminate battery. In addition, as the positive electrode active material used for the battery evaluation, LiCoO₂ was used.

The initial capacity of the laminate battery was 30 mAh. Subsequently, when the high temperature test was carried out, the amount of gas generated was 0.070 mL. Then, a square battery was prepared and the battery capacity was measured. The capacity was 800 mAh. Thereafter, the heating test was carried out in the same manner as the laminate battery, and after cooling, the battery capacity and the swelling of the battery were measured. As a result, the battery capacity was 710 mAh and the swelling of the battery was 1.20 mm.

### EXAMPLE 5

A battery was prepared in the same manner as in Example 3 except for using LiMn₂O₄ instead of LiCoO₂ which is a positive electrode active material in Example 3.

The initial capacity of the laminate battery was 25 mAh and the amount of gas generated was 0.140 mL.

Then, a square battery was prepared and the battery capacity was measured. The capacity was 670 mAh. Thereafter, the heating test was carried out in the same manner as the laminate battery, and after cooling, the battery capacity and the swelling of the battery were measured. As a result, the battery capacity was 540 mAh and the swelling of the battery was 1.40 mm.

### EXAMPLE 6

A battery was prepared in the same manner as in Example 3 except for using LiNiO₂ instead of LiCoO₂ which is a positive electrode active material in Example 3.

The initial capacity of the laminate battery was 35 mAh and the amount of gas generated was 0.171 mL. Then, a square battery was prepared and the battery capacity was measured. The capacity was 940 mAh. Thereafter, the heating test was carried out in the same manner as the laminate battery, and after cooling, the battery capacity and the swelling of the battery were measured. As a result, the battery capacity was 798 mAh and the swelling of the battery was 1.50 mm.

### EXAMPLE 7

A polymer E (the above chemical formula (9): R¹ is H, Y is COOH, W is CN, R² is H, R³ is H, R⁴ is H, a is 30 mole %, b is 35 mole % and c is 35 mole %) was synthesized by using 1-vinylnaphthalene (0.30 mol, 46.2 g), acrylic acid (0.35 mol, 25.2 g) and acrylonitrile (0.35 mol, 18.5 g). The polymer E was dissolved in the electrolytic solution at a concentration of 0.1% by weight to prepare a laminate battery. In addition, as the positive electrode active material used for the battery evaluation, LiCoO₂ was used.

The initial capacity of the laminate battery was 30 mAh. Subsequently, when the high temperature test was carried out, the amount of gas generated was 0.060 mL. Then, a square battery was prepared and the battery capacity was measured. The capacity was 800 mAh. Thereafter, the heating test was carried out in the same manner as the laminate battery, and after cooling, the battery capacity and the swelling of the battery were measured. As a result, the battery capacity was 721 mAh and the swelling of the battery was 1.11 mm.

### EXAMPLE 8

A polymer F (the above chemical formula (9): R¹ is H, Y is SO₃H, R² is H, R³ is H, a is 50 mole %, b is 50 mole % and c is 0 mole %) was synthesized by using 1-vinylnaphthalene (1 mol, 154 g) and vinyl sulfonic acid (1 mol, 108 g). The polymer E was dissolved in the electrolytic solution at a concentration of 0.1% by weight to prepare a laminate battery. In addition, as the positive electrode active material used for the battery evaluation, LiCoO₂ was used.

The initial capacity of the laminate battery was 30 mAh. Subsequently, when the high temperature test was carried out, the amount of gas generated was 0.065 mL. Then, a square battery was prepared and the battery capacity was measured. The capacity was 800 mAh. Thereafter, the heating test was carried out in the same manner as the laminate battery, and after cooling, the battery capacity and the swelling of the battery were measured. As a result, the battery capacity was 715 mAh and the swelling of the battery was 1.12 mm.

### COMPARATIVE EXAMPLE 1

A laminate battery was prepared in the same manner as in Example 1 except for using an electrolytic solution to which no polymer was added in Example 1.

The initial capacity of the laminate battery was 30 mAh. Subsequently, when the high temperature test was carried out, the amount of gas generated was 0.102 mL. Then, a square battery was prepared and the battery capacity was measured. The capacity was 800 mAh. Thereafter, the heating test was carried out in the same manner as the laminate battery, and after cooling, the battery capacity and the swelling of the battery were measured. As a result, the battery capacity was 560 mAh and the swelling of the battery was 1.40 mm.

### COMPARATIVE EXAMPLE 2

A laminate battery was prepared in the same manner as in Example 5 except for using an electrolytic solution to which no polymer was added in Example 5.

The initial capacity of the laminate battery was 25 mAh. Subsequently, when the high temperature test was carried out, the amount of gas generated was 0.200 mL. Then, a square battery was prepared and the battery capacity was measured. The capacity was 670 mAh. Thereafter, the heating test was carried out in the same manner as the laminate battery, and after cooling, the battery capacity and the swelling of the battery were measured. As a result, the battery capacity was 450 mAh and the swelling of the battery was 1.62 mm.

### COMPARATIVE EXAMPLE 3

A laminate battery was prepared in the same manner as in Example 6 except for using an electrolytic solution to which no polymer was added in Example 6.

The initial capacity of the laminate battery was 35 mAh. Subsequently, when the high temperature test was carried out, the amount of gas generated was 0.285 mL. Then, a square battery was prepared and the battery capacity was measured. The capacity was 940 mAh. Thereafter, the heating test was carried out in the same manner as the laminate battery, and after cooling, the battery capacity and the swelling of the battery were measured. As a result, the battery capacity was 660 mAh and the swelling of the battery was 2.20 mm.

### COMPARATIVE EXAMPLE 4

A laminate battery was prepared in the same manner as in Example 1 except for adding 1,3-propanesultone into the electrolytic solution at a concentration of 1% by weight instead of the polymer A in Example 1.

The initial capacity of the laminate battery was 27 mAh. Subsequently, when the high temperature test was carried out, the amount of gas generated was 0.080 mL. Then, a square battery was prepared and the battery capacity was measured. The capacity was 725 mAh. Thereafter, the heating test was carried out in the same manner as the laminate battery, and after cooling, the battery capacity and the swelling of the battery were measured. As a result, the battery capacity was 635 mAh and the swelling of the battery was 1.25 mm.

### COMPARATIVE EXAMPLE 5

A laminate battery was prepared in the same manner as in Example 1 except for changing the concentration of the polymer A in Example 1 to 0.009% by weight.

The initial capacity of the laminate battery was 30 mAh. Subsequently, when the high temperature test was carried out, the amount of gas generated was 0.095 mL. Then, a square battery was prepared and the battery capacity was measured. The capacity was 800 mAh. Thereafter, the heating test was carried out in the same manner as the laminate battery, and after cooling, the battery capacity and the swelling of the battery were measured. As a result, the battery capacity was 340 mAh and the swelling of the battery was 1.31 mm.

### COMPARATIVE EXAMPLE 6

A laminate battery was prepared in the same manner as in Example 1 except for changing the concentration of the polymer A in Example 1 to 6% by weight. The initial capacity of the laminate battery was 25 mAh. Subsequently, when the high temperature test was carried out, the amount of gas generated was 0.100 mL. Then, a square battery was prepared and the battery capacity was measured. The capacity was 670 mAh. Thereafter, the heating test was carried out in the same manner as the laminate battery, and after cooling, the battery capacity and the swelling of the battery were measured. As a result, the battery capacity was 540 mAh and the swelling of the battery was 1.35 mm.

Table 1 summarizes the above Examples and Comparative Examples.

TABLE 1

| | | | | | | | | Polymer |
|---|---|---|---|---|---|---|---|---|
| | | | | mol % | | | Polymer | Concentration |
| Examples | a | b | c | a | b | c | Name | wt % |
| 1 | 1-Vinylnaphthalene | Acrylic Acid | None | 50 | 50 | 0 | Polymer A | 0.1 |
| 2 | 2-Vinylnaphthalene | Acrylic Acid | None | 50 | 50 | 0 | Polymer B | 0.1 |
| 3 | 1-Vinylnaphthalene | Acrylic Acid | Diethyleneglycol | 30 | 35 | 35 | Polymer C | 0.1 |
| | | | Monomethylether | | | | | |
| | | | Methacrylate | | | | | |
| 4 | 1-Vinylnaphthalene | Acrylic Acid | Diethyleneglycol | 30 | 5 | 65 | Polymer D | 0.1 |
| | | | Monomethylether | | | | | |
| | | | Methacrylate | | | | | |
| 5 | 1-Vinylnaphthalene | Acrylic Acid | Diethyleneglycol | 30 | 35 | 35 | Polymer C | 0.1 |
| | | | Monomethylether | | | | | |
| | | | Methacrylate | | | | | |
| 6 | 1-Vinylnaphthalene | Acrylic Acid | Diethyleneglycol | 30 | 35 | 35 | Polymer C | 0.1 |
| | | | Monomethylether | | | | | |
| | | | Methacrylate | | | | | |
| 7 | 1-Vinylnaphthalene | Acrylic Acid | Acrylonitrile | 30 | 35 | 35 | Polymer E | 0.1 |
| 8 | 1-Vinylnaphthalene | Vinyl sulfonic Acid | None | 50 | 50 | 0 | Polymer F | 0.1 |

| | | | Laminate Battery | | Square Battery | | |
|---|---|---|---|---|---|---|---|
| | | | Initial | Amount of | Battery Capacity | Battery Capacity | Swelling of |
| | Positive Electrode | Negative Electrode | Capacity/ | Gas Generated/ | before Heating/ | after Heating/ | Battery/ |
| Examples | Active Material | Active Material | mAh | mL | mAh | mAh | mm |
| 1 | LiCoO₂ | Graphite | 30 | 0.060 | 800 | 720 | 1.10 |
| 2 | LiCoO₂ | Graphite | 30 | 0.065 | 800 | 718 | 1.11 |
| 3 | LiCoO₂ | Graphite | 30 | 0.055 | 800 | 735 | 1.08 |
| 4 | LiCoO₂ | Graphite | 30 | 0.070 | 800 | 710 | 1.20 |
| 5 | LiMn₂O₄ | Graphite | 25 | 0.140 | 670 | 540 | 1.40 |
| 6 | LiNiO₂ | Graphite | 35 | 0.171 | 940 | 798 | 1.50 |
| 7 | LiCoO₂ | Graphite | 30 | 0.060 | 800 | 721 | 1.11 |
| 8 | LiCoO₂ | Graphite | 30 | 0.065 | 800 | 715 | 1.12 |

| | | | | | | | | Polymer |
|---|---|---|---|---|---|---|---|---|
| Comparative | | | | mol % | | | Polymer | Concentration |
| Examples | a | b | c | a | b | c | Name | wt % |

| 1 | Only Electrolytic Solution | | | — | — | — | — | |
|---|---|---|---|---|---|---|---|---|
| 2 | Only Electrolytic Solution | | | — | — | — | — | |
| 3 | Only Electrolytic Solution | | | — | — | — | — | |
| 4 | Electrolytic Solution + | | | — | — | — | — | |
| | 1,3-propanesultone (1% by weight) | | | | | | | |
| 5 | 1-Vinylnaphthalene | Acrylic Acid | None | 30 | 35 | 35 | Polymer C | 0.009 |
| 6 | 1-Vinylnaphthalene | Acrylic Acid | None | 30 | 35 | 35 | Polymer C | 6 |

| | | | Laminate Battery | | Square Battery | | |
|---|---|---|---|---|---|---|---|
| | | | Initial | Amount of | Battery Capacity | Battery Capacity | Swelling of |
| Comparative | Positive Electrode | Negative Electrode | Capacity/ | Gas Generated/ | before Heating/ | after Heating/ | Battery/ |
| Examples | Active Material | Active Material | mAh | mL | mAh | mAh | mm |
| 1 | LiCoO₂ | Graphite | 30 | 0.102 | 800 | 560 | 1.40 |
| 2 | LiMn₂O₄ | Graphite | 25 | 0.200 | 670 | 450 | 1.62 |
| 3 | LiNiO₂ | Graphite | 35 | 0.285 | 940 | 660 | 2.20 |
| 4 | LiCoO₂ | Graphite | 27 | 0.080 | 725 | 635 | 1.25 |
| 5 | LiCoO₂ | Graphite | 30 | 0.095 | 800 | 640 | 1.31 |
| 6 | LiCoO₂ | Graphite | 25 | 0.100 | 670 | 540 | 1.35 |

Hereinafter, the constitution of the lithium secondary battery of Examples will be described using drawings.

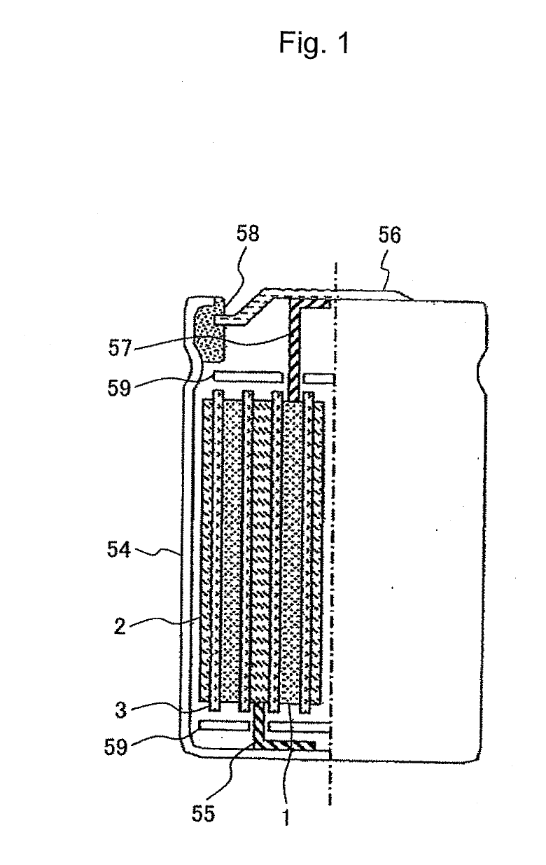

FIG. 1 is a partial sectional view showing a lithium secondary battery (cylindrical lithium-ion battery).

A positive electrode 1 and a negative electrode 2 are cylindrically wound so as not to come in direct contact with each other in a state of sandwiching a separator 3, thereby forming an electrode group. A positive lead 57 is attached to the positive electrode 1 and a negative lead 55 is attached to the negative electrode 2.

The electrode group is inserted into a battery can 54. An insulating plate 59 is disposed on the bottom and upper portions of the battery can 54 so that the electrode group may not come in direct contact with the battery can 54. The electrolytic solution is poured into the inside of the battery can 54.

The battery can 54 is sealed through a packing 58 in a state insulated from a cover portion 56.

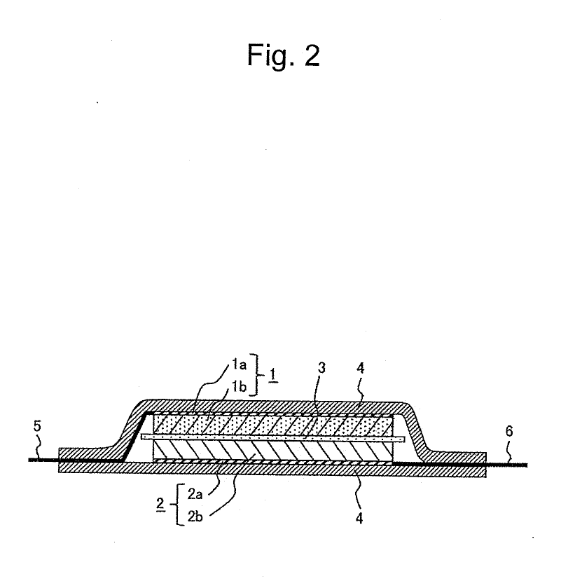

FIG. 2 is a cross-sectional view showing a secondary battery (laminate-type cell) of Examples.

The secondary battery shown in this view has a configuration in which a laminated body in a form sandwiching the separator 3 with the positive electrode 1 and the negative electrode 2 is sealed with a nonaqueous electrolytic solution by a packaging body 4. The positive electrode 1 comprises a positive electrode current collector 1a and a positive electrode mix layer 1b, and the negative electrode 2 comprises a negative electrode current collector 2a and a negative electrode mix layer 2b. The positive electrode current collector 1a is connected to a positive electrode terminal 5 and the negative electrode current collector 2a is connected to a negative electrode terminal 6.

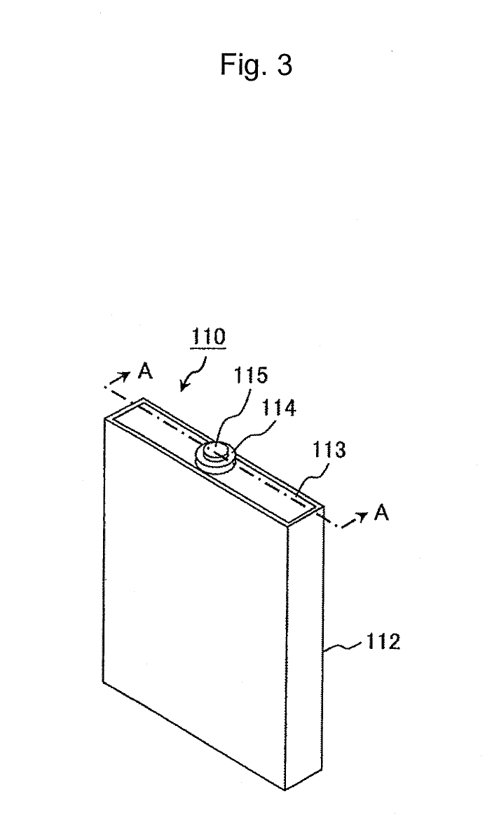

FIG. 3 is a perspective view showing a secondary battery (square battery) of Examples.

In this view, a battery 110 (nonaqueous electrolytic solution secondary battery) is prepared by enclosing a flat winding electrode body together with a nonaqueous electrolytic solution in a square exterior can 112. A terminal 115 is located at the central portion of a cover plate 113 through an insulating plate 114.

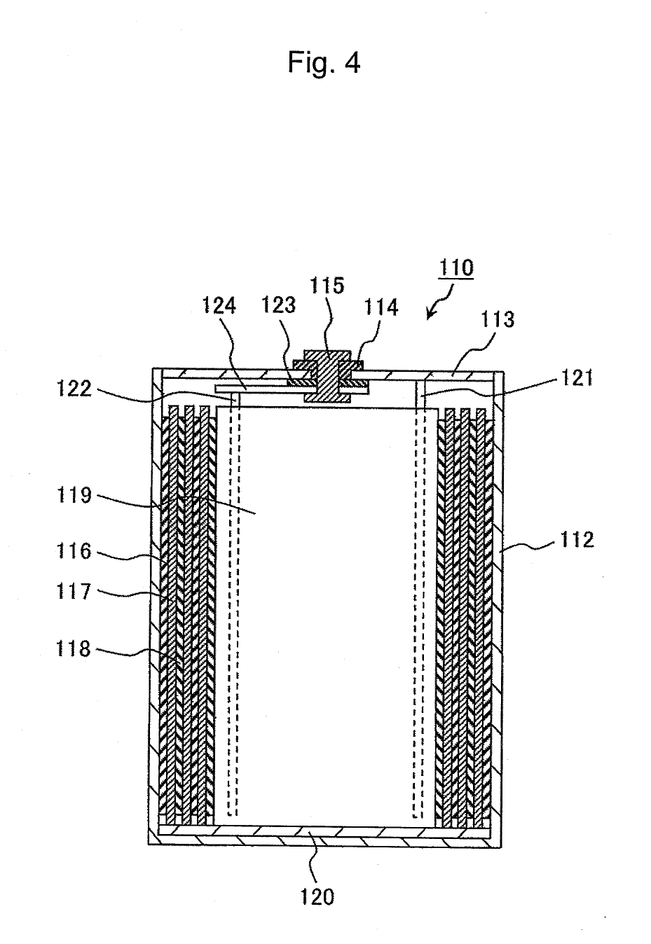

FIG. 4 is an A-A cross-sectional view of FIG. 3.

In this view, a positive electrode 116 and a negative electrode 118 are wound in a state of sandwiching a separator 117 to form a flat winding electrode body 119. An insulating body 120 is disposed at the bottom portion of the exterior can 112 so that the positive electrode 116 and the negative electrode 118 are not shortened.

The positive electrode 116 is connected to the cover plate 113 through a positive electrode lead body 121. On the other hand, the negative electrode 118 is connected to the terminal 115 through a negative electrode lead body 122 and a lead plate 124. An insulating body 123 is sandwiched so that the lead plate 124 and the cover plate 113 may not come in direct contact with each other.

The configuration of the secondary battery related to the above Examples is an example, and the secondary battery of the present invention is not limited to these Examples and comprises all of the secondary batteries to which the above overcharge inhibitor is applied.

The aromatic functional group contained in the above polymerizable compound and the polymer forms a protective film only on the surface of the positive electrode because electrons on the surface of the positive electrode are deprived and a polymerization reaction electrochemically occurs and no polymerization occurs on the surface of the negative electrode. Since a complex-forming functional group forming a complex with a metal ion is contained in the protective film, ions of Li, Mn, Ni and the like derived from the positive electrode active material form a complex and are fixed to the positive electrode. Accordingly, this can prevent the electrolytic solution from being decomposed by the catalytic reaction of the positive electrode active material and gas from being generated, and prevents these ions from being reduced by the negative electrode and being deposited.

The polymerizable compound and the polymer of the present invention are localized on the positive electrode to achieve the above effects and do not deteriorate the performance of the battery by reacting with the negative electrode, like a conventional electrolytic solution to which propane sultone or disulfonate or the like is added.

In addition, the above polymerizable compound and the polymer may be those which are not dissolved in the electrolytic solution. In this case, the polymerizable compound represented by the above chemical formula (6) or a residue thereof may not be incorporated. That is, no functional group having a highly polar group is required. In this case, the above polymerizable compound and the polymer may be dispersed in the electrolytic solution or be precipitated inside the battery.

Further, the above complex-forming functional group may be added to any of the sites of the above polymerizable compound and the polymer.

DESCRIPTION OF SYMBOLS
1: Positive Electrode
1a: Positive Electrode Current Collector
1b: Positive Electrode Mix Layer
2: Negative Electrode
2a: Negative Electrode Current Collector
2b: Negative Electrode Mix Layer
3: Separator
4: Packaging Body
5: Positive Electrode Terminal
6: Negative Electrode Terminal
54: Battery Can
55: Negative electrode Lead
56: Cover Portion
57: Positive Electrode Lead
58: Packing
59: Insulating Plate
101: Battery Can
102: Positive Electrode Terminal
103: Battery Cover
110: Battery
112: Exterior Can
113: Cover Plate
114: Insulating Body
115: Terminal
116: Positive Electrode
117: Separator
118: Negative Electrode
119: Flat Winding Electrode Body
120: Insulating Body
121: Positive Electrode Lead Body
122: Negative electrode Lead Body
123: Insulating Body
124: Lead Plate

What is claimed is:

1. A lithium secondary battery comprising a positive electrode, a negative electrode and an electrolyte, wherein the electrolyte comprises a polymerizable compound or a polymer, the polymerizable compound comprises a compound having an aromatic functional group and a polymerizable functional group and a compound having a complex-forming functional group forming a complex with a metal ion and a polymerizable functional group, and the polymer has the complex-forming functional group, the aromatic functional group and a residue of the polymerizable functional group.

2. The lithium secondary battery according to claim 1, wherein the polymerizable compound further comprises a compound having a highly polar functional group having a functional group with high polarity and a polymerizable functional group and the polymer further has the highly polar functional group.

3. The lithium secondary battery according to claim 1, wherein the aromatic functional group has the complex-forming functional group.

4. The lithium secondary battery according to claim 1, wherein the polymerizable compound or the polymer has a hydrocarbon group or an oxyalkylene group having 1 to 20 carbon atoms between the aromatic functional group and the polymerizable functional group.

5. The lithium secondary battery according to claim 1, wherein the complex-forming functional group is represented by —OR, —SR, —COOR or —SO₃R, wherein R is H, an alkyl metal, an alkaline earth metal or an alkyl group.

6. The lithium secondary battery according to claim 1, wherein the electrolyte comprises a polymerizable compound represented by the following chemical formula (1) or (2):
Z¹—X-A Chemical Formula (1)
Z¹-A Chemical Formula (2)
wherein, Z¹ is a polymerizable functional group, X is a hydrocarbon group or an oxyalkylene group having 1 to 20 carbon atoms, A is an aromatic functional group and at least a portion of the aromatic functional group may be substituted with —OR, —SR, —COOR or —SO₃R, wherein R is H, an alkali metal, an alkaline earth metal or an alkyl group.

7. The lithium secondary battery according to claim 1, wherein the electrolyte comprises a polymer represented by the following chemical formula (3) or (4): 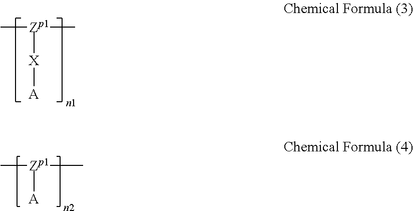
wherein, Z^{p1} is a residue of the polymerizable functional group, X is a hydrocarbon group or an oxyalkylene group having 1 to 20 carbon atoms, A is an aromatic functional group and at least a portion of the aromatic functional group may be substituted with —OR, —SR, —COOR or —SO₃R, wherein R is H, an alkali metal, an alkaline earth metal or an alkyl group; and further, n1 and n2 are each an integer of 1 or more.

8. The lithium secondary battery according to claim 1, wherein the electrolyte comprises polymerizable compounds represented by the following chemical formulas (5) and (6):
Z²—Y Chemical Formula (5)
Z³—W Chemical Formula (6)
wherein, Z² is a polymerizable functional group, Y is a complex-forming functional group forming a complex with a metal ion, Z³ is a polymerizable functional group and W is a highly polar functional group having a functional group with high polarity.

9. The lithium secondary battery according to claim 1, wherein the electrolyte comprises a polymer represented by the following chemical formula (7) or (8): 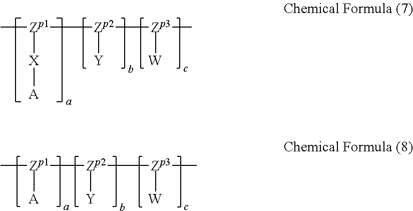
wherein, Z^{p1}, Z^{p2} and Z^{p3} are each a residue of the polymerizable functional group, a, b and c are expressed in mole %, X is a hydrocarbon group or an oxyalkylene group having 1 to 20 carbon atoms, A is an aromatic functional group, and at least a portion of the aromatic functional group may be substituted with —OR, —SR, —COOR or —SO₃R, wherein R is H, an alkali metal, an alkaline earth metal or an alkyl group; and further, Y is a complex-forming functional group forming a complex with a metal ion and W is a highly polar functional group having a functional group with high polarity.

10. The lithium secondary battery according to claim 1, wherein the electrolyte comprises a polymer represented by the following chemical formula (9) or (10): 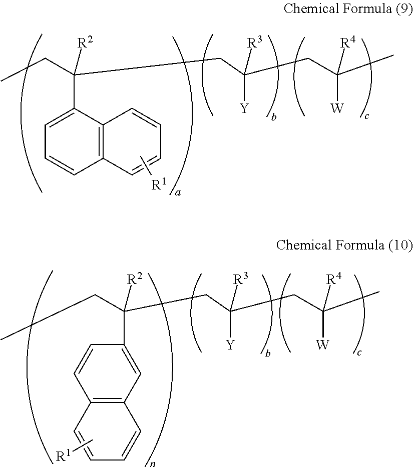
wherein, R¹ is H, a chain hydrocarbon group, a cyclic hydrocarbon group, an aromatic group, OR, SR, COOR or SO₃R, wherein R is H, an alkali metal, an alkaline earth metal or an alkyl group; and further, a, b and c are expressed in mole %, Y is a complex-forming functional group forming a complex with a metal ion, W is a highly polar functional group having a functional group with high polarity, and R², R³ and R⁴ are each H or a hydrocarbon group.

11. The lithium secondary battery according to claim 1, wherein a square battery can is used.

12. A polymer represented by the following chemical formula (9) or (10): 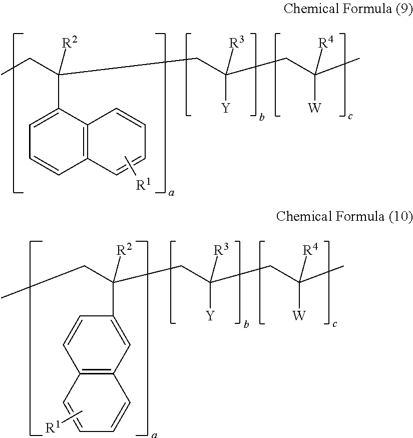
wherein, R¹ is H, a chain hydrocarbon group, a cyclic hydrocarbon group, an aromatic group, OR, SR, COOR or SO₃R, wherein R is H, an alkali metal, an alkaline earth metal or an alkyl group; and further, a, b and c are expressed in mole %, Y is a complex-forming functional group forming a complex with a metal ion, W is a highly polar functional group having a functional group with high polarity, and R², R³ and R⁴ are each H or a hydrocarbon group.

13. An electrolytic solution for a lithium secondary battery, wherein the electrolytic solution comprises the polymerizable compound or the polymer comprised in the lithium secondary battery according to claim 1.

14. A positive electrode protective agent for a lithium secondary battery, wherein the polymerizable compound or the polymer comprised in the lithium secondary battery according to claim 1 is used as an active component.

15. A method for manufacturing a polymer comprising: preparing a mixture comprising a polymerizable compound having an aromatic functional group and a polymerizable functional group, and a polymerizable compound having a complex-forming functional group forming a complex with a metal ion and a polymerizable functional group; and polymerizing the polymerizable compounds.

16. The method for manufacturing a polymer according to claim 15, wherein the polymerizable compound has a hydrocarbon group or an oxyalkylene group having 1 to 20 carbon atoms between the aromatic functional group and the polymerizable functional group.

17. The method for manufacturing a polymer according to claim 15, wherein the mixture comprises a polymerizable compound represented by the following chemical formula (1) or (2) and polymerizable compounds represented by the following chemical formulas (5) and (6):
Z¹—X-A Chemical Formula (1)
Z¹-A Chemical Formula (2)
Z²—Y Chemical Formula (5)
Z³—W Chemical Formula (6)
wherein, Z¹ is a polymerizable functional group, X is a hydrocarbon group or an oxyalkylene group having 1 to 20 carbon atoms, A is an aromatic functional group and at least a portion of the aromatic functional group may be substituted with —OR, —SR, —COOR or —SO₃R, wherein R is H, an alkali metal, an alkaline earth metal or an alkyl group; Z² is a polymerizable functional group, Y is a complex-forming functional group forming a complex with a metal ion, Z³ is a polymerizable functional group and W is a highly polar functional group having a functional group with high polarity.

18. The method for manufacturing a polymer according to claim 15, wherein the mixture further comprises a polymerizable compound having a highly polar functional group having a functional group with high polarity and a polymerizable functional group.

19. The method for manufacturing a polymer according to claim 15, wherein the mixture is mixed and reacted with a polymerization initiator.
